(19) United States
(12) Patent Application Publication
(10) Pub. No.: US 2024/0144064 A1
(43) Pub. Date: May 2, 2024

(54) PRUNING QUANTUM COMPUTATIONAL RESULTS

(71) Applicant: International Business Machines Corporation, Armonk, NY (US)

(72) Inventors: Ryan Woo, Tenafly, NJ (US); Jessie Yu, Pleasant Valley, NY (US); Atsuko Shimizu, Mount Kisco, NY (US); Diego Moreda Rodriguez, Ribadeo (ES)

(21) Appl. No.: 18/090,565

(22) Filed: Dec. 29, 2022

(30) Foreign Application Priority Data
Oct. 28, 2022 (EP) 22383046.4

(51) Int. Cl. G06N 10/20

(52) U.S. Cl. CPC G06N 10/20

(57) ABSTRACT

A computer-implemented method, system and computer program product for pruning quantum calculational results. The results of quantum calculations performed by a quantum circuit of a quantum computer are received, such as for each shot. A measured state of a quantum bit of a result of the quantum calculation is then compared with an expected value. If the compared measured state of the quantum bit of the result of the quantum calculation matches the expected value, then the result of the quantum calculation is not discarded. If, however, the measured state of the quantum bit of the result of the quantum calculation does not match the expected value, then the result of the quantum calculation is discarded. In this manner, the size of the full result (compilation of multiple shot results) is reduced thereby reducing the amount of classical data that needs to be stored, interpreted and transported.

### TECHNICAL FIELD

The present disclosure relates generally to quantum computing, and more particularly to pruning quantum computational results.

### BACKGROUND

Quantum computing is a type of computation that harnesses the collective properties of quantum states, such as superposition, interference, and entanglement, to perform calculations. The devices that perform quantum computations are known as quantum computers. Though current quantum computers are too small to outperform usual (classical) computers for practical applications, they are believed to be capable of solving certain computational problems, such as integer factorization, substantially faster than classical computers.

There are several types of quantum computers (also known as quantum computing systems), including the quantum circuit model, quantum Turing machine, adiabatic quantum computer, one-way quantum computer, and various quantum cellular automata. The most widely used model is the quantum circuit, based on the quantum bit, or “qubit,” which is somewhat analogous to the bit in classical computation. A qubit can be in a 1 or 0 quantum state, or in a superposition of the 1 and 0 states. When it is measured, however, it is always 0 or 1 where the probability of either outcome depends on the qubit's quantum state immediately prior to measurement.

Quantum programming is the process of assembling sequences of instructions, called quantum programs, that are capable of running on a quantum computer. Quantum programming languages help express quantum algorithms using high-level constructs. A quantum program completes when the quantum circuit has been executed within a defined number of shots. A “shot” refers to one complete execution of the quantum circuit.

The result space for a quantum program grows exponentially with the number of quantum bits measured. For example, for a quantum circuit with n measured quantum bits, there are up to 2′ possible shot results. Such shot results correspond to classical data that need to be stored or transmitted, such as to a classical storage device, for a given quantum circuit.

As the shot number increases, therefore, a full result (compilation of multiple shot results) can potentially have very large results in terms of classical data usage.

Currently, such an issue is addressed by returning combinations of equal shot results (i.e., two shot results are the same). However, this approach fails for noisy quantum computers because there can a large number of unique shot results simply due to noise. For example, one quantum algorithm for noisy quantum computers may need 10⁶ unique results, which can generate more data than is necessary for the algorithm to complete.

As a result, there is not currently a means for effectively reducing the amount of classical data that needs to be stored or transmitted for a given quantum circuit.

### SUMMARY

In one embodiment of the present disclosure, a method for pruning quantum computational results comprises receiving a plurality of results of quantum calculations from a quantum computer. The method further comprises discarding a first result of the plurality of results of quantum calculations in response to a measured state of a quantum bit of the first result not matching an expected value.

Additionally, in one embodiment of the present disclosure, the method further comprises building a list of nodes, each node representing a quantum bit. The method additionally comprises sorting the list of nodes based on a quality of the quantum bits.

Furthermore, in one embodiment of the present disclosure, the method additionally comprises calculating a number of shots each quantum bit needs to confidently determine a result.

Additionally, in one embodiment of the present disclosure, the method further comprises updating a count of 0s and 1s in nodes based on a value of the first result for those nodes that have not reached the number of shots its represented quantum bit needs to confidently determine a result.

Furthermore, in one embodiment of the present disclosure, the method additionally comprises discarding the first result of the plurality of results in response to a count of the first result appearing less often than a threshold number of times.

Additionally, in one embodiment of the present disclosure, the method further comprises discarding the first result of the plurality of results in response to a count of the first result within a designated number of shots appearing less often than a threshold number of times.

Furthermore, in one embodiment of the present disclosure, the method additionally comprises categorizing a result of each measured quantum bit of the quantum calculations as a feature. The method further comprises performing a multiple correspondence analysis on the features to map to a lower-dimensional continuous dataset. Furthermore, the method comprises clustering the lower-dimensional continuous dataset to form clusters. Additionally, the method comprises storing a closest percentage of data in each cluster and discarding remaining data in each cluster.

Other forms of the embodiments of the method described above are in a system and in a computer program product.

In this manner, the size of the full result (compilation of multiple shot results) is reduced thereby reducing the amount of classical data that needs to be stored, interpreted and transported. As a result, the response time is improved while utilizing less resource consumption. Furthermore, there is faster performance and better scaling for large quantum computers (e.g., tens of thousands of qubits).

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components of the classical computer for pruning quantum computational results in accordance with an embodiment of the present disclosure;

FIG. 3 illustrates a list of nodes sorted based on error rate in accordance with an embodiment of the present disclosure;

FIG. 4 illustrates running the list of nodes to determine which results of the quantum calculations are saved or discarded in accordance with an embodiment of the present invention;

FIG. 5 illustrates running the list of nodes to determine which results of the quantum calculations are saved or discarded involving a subsequent shot to the shot run in FIG. 4 in accordance with an embodiment of the present disclosure;

FIG. 6 illustrates an embodiment of the present disclosure of the hardware configuration of the classical computer which is representative of a hardware environment for practicing the present disclosure;

FIG. 7 is a flowchart of a method for pruning quantum computational results based on shot result counts in accordance with an embodiment of the present disclosure;

FIG. 8 is a flowchart of a method for pruning quantum computational results based on multiple correspondence analysis and clustering techniques in accordance with an embodiment of the present disclosure;

FIG. 9 is a flowchart of a method for pruning quantum computational results based on individual quantum bit values in accordance with an embodiment of the present disclosure;

FIG. 10 is a flowchart of a method for generating the expected value for each quantum bit represented by a node in accordance with an embodiment of the present disclosure; and

FIG. 11 is a flowchart of a method for running the list of nodes to determine which results of the quantum calculations are saved or discarded in accordance with an embodiment of the present disclosure.

### DETAILED DESCRIPTION

As stated in the Background section, quantum programming is the process of assembling sequences of instructions, called quantum programs, that are capable of running on a quantum computer. Quantum programming languages help express quantum algorithms using high-level constructs. A quantum program completes when the quantum circuit has been executed within a defined number of shots. A “shot” refers to one complete execution of the quantum circuit.

The result space for a quantum program grows exponentially with the number of quantum bits measured. For example, for a quantum circuit with n measured quantum bits, there are up to 2ⁿ possible shot results. Such shot results correspond to classical data that need to be stored or transmitted, such as to a classical storage device, for a given quantum circuit.

As the shot number increases, therefore, a full result (compilation of multiple shot results) can potentially have very large results in terms of classical data usage.

Currently, such an issue is addressed by returning combinations of equal shot results (i.e., two shot results are the same). However, this approach fails for noisy quantum computers because there can a large number of unique shot results simply due to noise. For example, one quantum algorithm for noisy quantum computers may need 10⁶ unique results, which can generate more data than is necessary for the algorithm to complete.

As a result, there is not currently a means for effectively reducing the amount of classical data that needs to be stored or transmitted for a given quantum circuit.

The embodiments of the present disclosure provide a means for reducing the size of the full result (compilation of multiple shot results) thereby reducing the amount of classical data that needs to be stored, interpreted or transmitted for a given quantum circuit by discarding shot results based on multiple algorithms (e.g., discarding shot results if they appear less often than a threshold number of times) or based on discarding the shot results if the measured state of a quantum bit of the results does not match an expected value as discussed further below. In one embodiment, the expected value of a quantum bit may be determined by counting the number of 0s and 1s corresponding to the state of the quantum bit after each shot until the number of shots equals the number of shots (e.g., 500 shots) needed to confidently determine an expected value. The expected value then corresponds to the value (0 or 1) that contains the highest count.

In some embodiments of the present disclosure, the present disclosure comprises a computer-implemented method, system and computer program product for pruning quantum calculational results. In one embodiment of the present disclosure, the results of quantum calculations performed by a quantum circuit of a quantum computer are received, such as for each shot. A “shot,” as used herein, refers to one complete execution of the quantum circuit. The number of shots defines how many times the quantum circuit is to be repeatedly executed so as to obtain a better readout of a state, such as a state of a quantum bit. A measured state of a quantum bit of a result of the quantum calculation is then compared with an expected value. For example, the measured state of a quantum bit (e.g., 0) of the result of the quantum calculation may be compared with its expected value (e.g., 1). In one embodiment, the expected value of a quantum bit may be determined by counting the number of 0s and 1s corresponding to the state of the quantum bit after each shot until the number of shots equals the number of shots (e.g., 500 shots) needed to confidently determine an expected value. The expected value then corresponds to the value (0 or 1) that contains the highest count. If the compared measured state of the quantum bit of the result of the quantum calculation (e.g., measured state of the quantum bit is 1) matches the expected value (e.g., 1), then the result of the quantum calculation is not discarded. If, however, the measured state of the quantum bit of the result of the quantum calculation (e.g., measured state of the quantum bit is 0) does not match the expected value (e.g., 1), then the result of the quantum calculation is discarded. In this manner, the size of the full result (compilation of multiple shot results) is reduced thereby reducing the amount of classical data that needs to be stored, interpreted and transported.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill the relevant art.

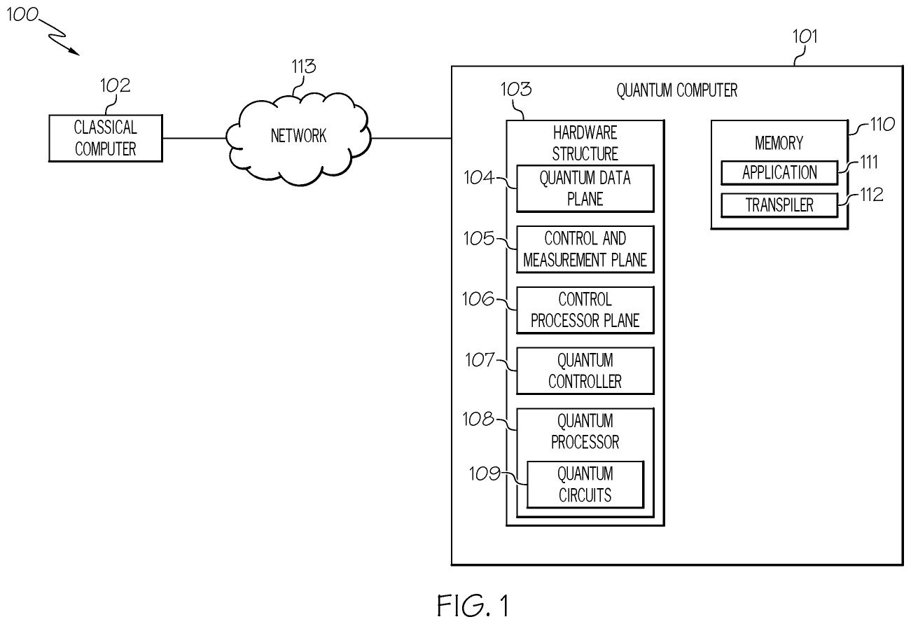

Referring now to the Figures in detail, FIG. 1 illustrates an embodiment of the present disclosure of a communication system 100 for practicing the principles of the present disclosure. Communication system 100 includes a quantum computer 101 configured to perform quantum computations, such as the types of computations that harness the collective properties of quantum states, such as superposition, interference and entanglement, as well as a classical computer 102 in which information is stored in bits that are represented logically by either a 0 (off) or a 1 (on). Examples of classical computer 102 include, but not limited to, a portable computing unit, a Personal Digital Assistant (PDA), a laptop computer, a mobile device, a tablet personal computer, a smartphone, a mobile phone, a navigation device, a gaming unit, a desktop computer system, a workstation, and the like configured with the capability of connecting to network 113 (discussed below).

In one embodiment, classical computer 102 is used to setup the state of quantum bits in quantum computer 101 and then quantum computer 101 starts the quantum process. Furthermore, in one embodiment, classical computer 102 is configured to reduce the size of the full result (compilation of multiple shot results) thereby reducing the amount of classical data that needs to be stored, interpreted or transported for a given quantum circuit by discarding shot results based on multiple algorithms (e.g., discarding shot results if they appear less often than a threshold number of times) or based on discarding the shot results if the measured state of a quantum bit of the results does not match an expected value as discussed further below.

In one embodiment, a hardware structure 103 of quantum computer 101 includes a quantum data plane 104, a control and measurement plane 105, a control processor plane 106, a quantum controller 107 and a quantum processor 108.

Quantum data plane 104 includes the physical qubits or quantum bits (basic unit of quantum information in which a qubit is a two-state (or two-level) quantum-mechanical system) and the structures needed to hold them in place. In one embodiment, quantum data plane 104 contains any support circuitry needed to measure the qubits' state and perform gate operations on the physical qubits for a gate-based system or control the Hamiltonian for an analog computer. In one embodiment, control signals routed to the selected qubit(s) set a state of the Hamiltonian. For gate-based systems, since some qubit operations require two qubits, quantum data plane 104 provides a programmable “wiring” network that enables two or more qubits to interact.

Control and measurement plane 105 converts the digital signals of quantum controller 107, which indicates what quantum operations are to be performed, to the analog control signals needed to perform the operations on the qubits in quantum data plane 104. In one embodiment, control and measurement plane 105 converts the analog output of the measurements of qubits in quantum data plane 104 to classical binary data that quantum controller 107 can handle.

Control processor plane 106 identifies and triggers the sequence of quantum gate operations and measurements (which are subsequently carried out by control and measurement plane 105 on quantum data plane 104). These sequences execute the program, provided by quantum processor 108, for implementing a quantum algorithm.

In one embodiment, control processor plane 106 runs the quantum error correction algorithm (if quantum computer 101 is error corrected).

In one embodiment, quantum processor 108 uses qubits to perform computational tasks. In the particular realms where quantum mechanics operate, particles of matter can exist in multiple states, such as an “on” state, an “off” state and both “on” and “off” states simultaneously. Quantum processor 108 harnesses these quantum states of matter to output signals that are usable in data computing.

In one embodiment, quantum processor 108 performs algorithms which conventional processors are incapable of performing efficiently. In one embodiment, quantum processor 108 includes its own data, boot files, operating system images and applications. Alternatively, as discussed further below, memory 110 may provide data, such as boot files, operating system images and applications, to quantum processor 108.

In one embodiment, quantum processor 108 includes one or more quantum circuits 109. Quantum circuits 109 may collectively or individually be referred to as quantum circuits 109 or quantum circuit 109, respectively. A “quantum circuit 109,” as used herein, refers to a model for quantum computation in which a computation is a sequence of quantum logic gates, measurements, initializations of qubits to known values and possibly other actions. A “quantum logic gate,” as used herein, is a reversible unitary transformation on at least one qubit. Quantum logic gates, in contrast to classical logic gate, are reversible. Examples of quantum logic gates include RX (performs e^{iθX} which corresponds to a rotation of the qubit state around the X-axis by the given angle theta θ on the Bloch sphere), RY (performs e^{iθY}, which corresponds to a rotation of the qubit state around the Y-axis by the given angle theta θ on the Bloch sphere), RXX (performs the operation e^{(-iθ/2X}^{_{⊕}}^{X)} on the input qubit), RZZ (takes in one input, an angle theta θ expressed in radians, and it acts on two qubits), etc. In one embodiment, quantum circuits 109 are written such that the horizontal axis is time, starting at the left hand side and ending at the right hand side.

Furthermore, in one embodiment, quantum circuit 109 corresponds to a command structure provided to control processor plane 106 on how to operate control and measurement plane 105 to run the algorithm on quantum data plane 104/quantum processor 108.

Furthermore, as discussed above, quantum computer 101 includes memory 110 which may provide data, such as boot files, operating system images, and applications (e.g., applications 111) to quantum processor 108. In one embodiment, memory 110 may correspond to quantum memory. In one embodiment, memory 110 is a set of quantum bits that store quantum states for later retrieval. The state stored in quantum memory 110 can retain quantum superposition.

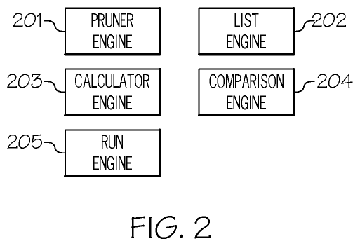

In one embodiment, memory 110 includes an application 111 that may be configured to implement one or more of the methods described herein in accordance with one or more embodiments. For example, application 111 may implement a program for pruning quantum computational results as discussed further below in connection with FIGS. 2-11. Examples of memory 110 include light quantum memory, solid quantum memory, gradient echo memory, electromagnetically induced transparency, etc.

Furthermore, in one embodiment, memory 110 stores a “transpiler 112,” which as used herein, is configured to rewrite an abstract quantum circuit 109 into a functionally equivalent one that matches the constraints and characteristics of a specific target quantum device. In one embodiment, transpiler 112 (e.g., qiskit.transpiler, where Qiskit is an open-source software development kit for working with quantum computers at the level of circuits, pulses and algorithms) converts the trained machine learning model upon execution on quantum hardware 103 to its elementary instructions and maps it to physical qubits.

In one embodiment, quantum machine learning models are based on variational quantum circuits 109. Such models consist of data encoding, processing parameterized with trainable parameters and measurement/post-processing.

In one embodiment, the number of qubits (basic unit of quantum information in which a qubit is a two-state (or two-level) quantum-mechanical system) is determined by the number of features in the data. This processing stage may include multiple layers of parameterized gates. As a result, in one embodiment, the number of trainable parameters is (number of features)*(number of layers).

Furthermore, as shown in FIG. 1, classical computer 102, which is used to setup the state of quantum bits in quantum computer 101, may be connected to quantum computer 101 via a network 113.

Network 113 may be, for example, a quantum network, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, a cellular network and various combinations thereof, etc. Other networks, whose descriptions are omitted here for brevity, may also be used in conjunction with system 100 of FIG. 1 without departing from the scope of the present disclosure.

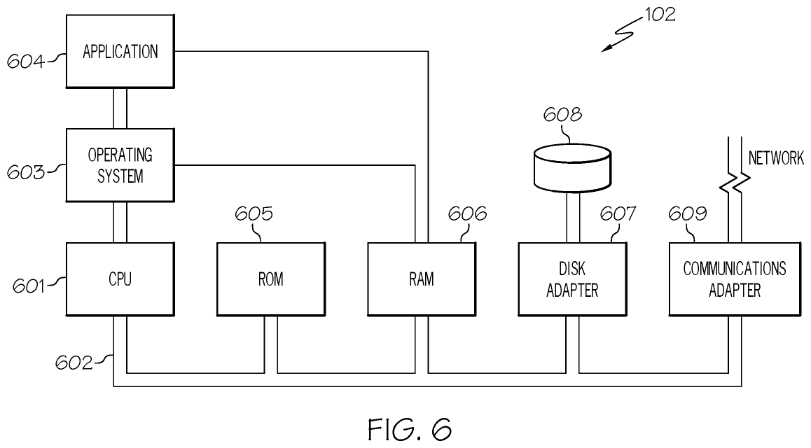

Furthermore, classical computer 102 is configured to prune quantum computational results such that the size of the full result (compilation of multiple shot results) is reduced thereby reducing the amount of classical data that needs to be stored, interpreted and transported for a given quantum circuit by discarding shot results based on multiple algorithms (e.g., discarding shot results if they appear less often than a threshold number of times) or based on discarding the shot results if the measured state of a quantum bit of the results does not match an expected value as discussed further below in connection with FIGS. 2-11. A description of the software components of classical computer 102 is provided below in connection with FIG. 2 and a description of the hardware configuration of classical computer 102 is provided further below in connection with FIG. 6.

System 100 is not to be limited in scope to any one particular network architecture. System 100 may include any number of quantum computers 101, classical computers 102 and networks 113.

A discussion regarding the software components used by classical computer 102 for pruning quantum computational results is provided below in connection with FIG. 2.

FIG. 2 is a diagram of the software components of classical computer 102 (FIG. 1) for pruning quantum computational results such that the size of the full result (compilation of multiple shot results) is reduced thereby reducing the amount of classical data that needs to be stored, interpreted and transported for a given quantum circuit in accordance with an embodiment of the present disclosure.

Referring to FIG. 2, in conjunction with FIG. 1, classical computer 102 includes a pruner engine 201 configured to discard shot results based on multiple algorithms.

In one embodiment, pruner engine 201 is configured to receive the results of the quantum calculations performed by quantum circuit 109 of quantum computer 101 for each shot. A “shot,” as used herein, refers to one complete execution of quantum circuit 109. The number of shots defines how many times quantum circuit 109 is to be repeatedly executed so as to obtain a better readout of a state of a quantum bit.

Furthermore, in one embodiment, pruner engine 201 counts the number of occurrences for each of the same shot results. For example, if the shot result for the execution of quantum circuit 109 was 001, then pruner engine 201 counts the number of occurrences for the shot result 001 in the results of the quantum calculations from quantum computer 101. For example, in one embodiment, pruner engine 201 utilizes the count( ) function for counting the number of times a shot result occurs in the results of the quantum calculations from quantum computer 101.

A “quantum program,” as discussed herein, defines the quantum circuit and the number of shots to execute quantum circuit 109. After quantum circuit 109 has completed the number of shots defined in the quantum program thereby providing a full result (compilation of multiple shot result), pruner engine 201 determines for each shot result whether the count (e.g., 3) of the shot result (e.g., 001) is less than a threshold number (e.g., 5), which may be user-designated, such as from an expert or administrator.

If the count of the shot result is less than a threshold number, then the shot result is discarded thereby reducing the size of the full result (compilation of multiple shot results) as well as reducing the amount of classical data that needs to be stored, interpreted and transported for a given quantum circuit.

For example, in one embodiment, pruner engine 201 utilizes a naïve algorithm. For example, the pseudocode for such an algorithm is shown below:

```
Input: ε (threshold), results
For result in results:
  if result < ε * length(results):
    delete result from results
Return results
```

If, however, the count of the shot result is not less than a threshold number, then pruner engine 201 determines whether the count of the shot result within the first user-designated number of shots is less than a user-designated threshold number, where such user-designated values may be provided from an expert or administrator. For example, if the count of the shot result is 2 within the first user-designated number of shots (e.g., 100 shots), then a determination is made by pruner engine 201 as to whether such a count is less than the user-designated threshold number (e.g., 3).

If the count of the shot result within the first user-designated number of shots is less than the user-designated threshold number, then the shot result is discarded thereby reducing the size of the full result (compilation of multiple shot results) as well as reducing the amount of classical data that needs to be stored, interpreted and transported for a given quantum circuit. Otherwise, the shot result is stored.

For example, in one embodiment, pruner engine 201 utilizes naïve filtering while running the solution for making such a determination. For example, the pseudocode for such an algorithm, where “m” corresponds to the user-designated number of shots, is shown below:

```
Input: ε (threshold), shots, m (warm up shots)
For i, shot in enumerate(shots):
  run shot, measure result
  if i >= m
    if result + saved results >= ε * i
      save result
  else:
    save result
Return results
```

In another example, pruner engine 201 utilizes a decision tree based filtering algorithm for discarding shot results with a count within the first user-designated number of shots being less than a user-designated threshold number. In one embodiment, the quantum bit results correspond to the features of the decision tree. In one embodiment, such a decision tree is pruned to a user-designated entropy.

Alternatively, in one embodiment, pruner engine 201 utilizes multiple correspondence analysis (MCA) and clustering techniques for discarding shot results thereby reducing the size of the full result (compilation of multiple shot results) as well as reducing the amount of classical data that needs to be stored, interpreted and transported for a given quantum circuit. MCA is a data analysis technique for nominal categorical data used to detect and represent underlying structures in a data set. In one embodiment, MCA is used to represent data as points in a low-dimensional Euclidean space.

In one embodiment, pruner engine 201 receives the results of the quantum calculations performed by a quantum circuit, such as quantum circuit 109. In one embodiment, the result of each measured quantum bit of the quantum calculations is categorized as a feature.

In one embodiment, pruner engine 201 performs multiple correspondence analysis on the features to map to a lower-dimensional continuous dataset. In one embodiment, such features are mapped to a lower-dimensional continuous dataset by creating a matrix with values of zero or one. If a categorical variable has more than two different classes, this method binarized it. By using this method, MCA creates a matrix that consists of individual variables. Applying a standard correspondence analysis on this matrix is the next step. The result is a linear combination of rows that carries the most possible information of all categorical features.

In one embodiment, pruner engine 201 clusters the lower-dimensional continuous dataset to form clusters.

For example, in one embodiment, the number of clusters to identify is selected (e.g., K). K number of new points are then randomly generated. The distance between each data point and each centroid is measured. Each data point is then assigned to its closest centroid and the corresponding cluster.

In another example, in one embodiment, pruner engine 201 utilizes k-means clustering. In such an algorithm, the data space is divided into K distinct clusters. In one embodiment, K cluster centers are randomly selected and all data points are assigned to the nearest cluster centers. Then the cluster centers are re-calculated as the centroids of the newly formed clusters. The data points are re-assigned to the nearest cluster centers that were just re-calculated. This process, assigning data points to the cluster centers and re-calculating the cluster centers, is repeated until the cluster centers stop moving.

In one embodiment, pruner engine 201 stores the closest percentage of data in each cluster and discards the remaining data in each cluster. “Closest percentage of data,” as used herein, refers to the percentage of data closest to its assigned centroid. For example, pruner engine 201 may store the closest 5% of data in each cluster while discarding the remaining data. In one embodiment, such a percentage is user-designated, such as from an expert or administrator.

Furthermore, classical computer 102 includes a list engine 202 configured to build a list of nodes, each node representing a quantum bit. In one embodiment, list engine 202 builds a list of nodes, each node representing a quantum bit, by creating a class Node with the attributes of data (corresponding to the error rate) and next (corresponding to a pointer to the next node in the list). Furthermore, in one embodiment, list engine 202 uses the addNode( ) function to add a new node to the list.

In one embodiment, list engine 202 is configured to sort the list of nodes based on the quality of quantum bits. That is, list engine 202 is configured to sort the list of nodes based on the error rates of the represented quantum bits, where the nodes listed higher in the list are representing quantum bits having a higher quality (lower error rate) than those nodes listed lower in the list. In one embodiment, list engine 202 sorts the list of nodes by creating a class SortList with the attributes of head and tail. The sortList( ) function is then used to sort the list of nodes by error rate.

In one embodiment, the error rate of a quantum bit represented by a node is calculated by list engine 202 by aggregating the number of errors for the quantum bit. In one embodiment, such errors include readout error, gate error (e.g., Pauli-X if the gate is applied on the quantum bit), crosstalk, etc. In one embodiment, quantum error correction (QEC) is utilized by list engine 202 to identify errors, such as employing syndrome measurements to diagnose which error corrupts an encoded state of the quantum bit. In one embodiment, a multi-qubit measurement is performed that does not disturb the quantum information in the encoded state but retrieves information about the error. Depending on the QEC code used, syndrome measurements can determine the occurrence, location and type of errors.

Upon creating a list of nodes, each node representing a quantum bit, where the list of nodes is sorted based on the quality of the quantum bits, calculator engine 203 of classical computer 102 is utilized to calculate the number of shots each quantum bit needs to confidently determine a result. “Confidently” determining a result, as used herein, refers to being assured that the result is correct. In one embodiment, calculator engine 203 calculates the number of shots needed to drown out the aggregated error previously computed by list engine 202, where such a number of shots corresponds to the number of shots a quantum bit needs to confidently determine a result. In one embodiment, calculator engine 203 calculates the number of such shots by using a binomial distribution. For example, calculator engine 203 uses a confidence level and the number of correct readouts, both of which are configurable. For example, calculator engine 203 may solve the problem of calculating the number of shots required such that with high confidence (e.g., 90%), there will be at least 950 correct readouts given the probability of success is 1 minus the aggregated error. For instance, such a distribution may be modeled as: 0.95>=(n+1)(½)ⁿ, where n is the number of shots. Calculator engine 203 would then simply solve for n, corresponding to the number of shots the quantum bit needs to confidently determine a result.

Classical computer 102 further includes a comparison engine 204 configured to compare a measured state of a quantum bit of a result of the quantum calculations with an expected value for each shot. A further discussion regarding comparison engine 204 is discussed below.

Classical computer 102 additionally includes a run engine 205 configured to determine if the measured state of the quantum bit of the result matches an expected value. If the measured state of the quantum bit of the result matches the expected value, then the result is not discarded by run engine 205. Otherwise, the result is discarded by run engine 205 thereby reducing the size of the full result (compilation of multiple shot results) which reduces the amount of classical data that needs to be stored, interpreted and transported for a given quantum circuit.

As discussed above, comparison engine 204 compares the measured state of a quantum bit of the result of the quantum calculations with the expected value for each shot. In one embodiment, the expected value is obtained in connection with creating the list of nodes by list engine 202.

In one embodiment, the list contains a list of nodes, each node representing a quantum bit, in which the head of the list corresponds to the quantum bit with the lowest error rate and the tail of the list corresponds to the quantum bit with the highest error rate.

In one embodiment, list engine 202 starts each node in the list with the counts for 0s and 1s, which are initialized at 0. Such counts are updated with each shot execution. In one embodiment, once the desired shot count (corresponding to the number of shots the quantum bit needs to confidently determine a result as discussed above) is reached for that particular node, the value (0 or 1) that contains the highest count becomes the expected value.

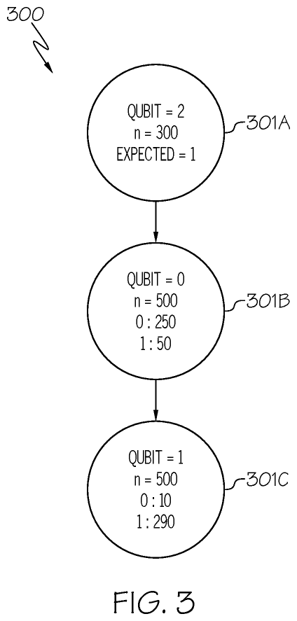

For example, as shown in FIG. 3, FIG. 3 illustrates a list 300 of nodes sorted based on error rate in accordance with an embodiment of the present disclosure.

As shown in FIG. 3, list 300 includes node 301A representing the quantum bit (qubit) of 2, where n (number of shots the quantum bit needs to confidently determine a result) equals 300 and the expected value is 1. That is, in list 300, node 301A corresponds to the head of list 300 thereby indicating that qubit 2 has the lowest error rate. Furthermore, node 301A indicates that after 300 shots (number of shots needed to confidently determine a correct value), the expected value for qubit 2 is 1.

Furthermore, as shown in FIG. 3, node 301B represents the quantum bit (qubit) of 0, where n (number of shots the quantum bit needs to confidently determine a result) equals 500, and the counts of 0 and 1 are 250 and 50, respectively. The expected value for qubit 0 is undetermined because in this instance the number of shots has not reached the shot threshold n for that particular node.

Additionally, as shown in FIG. 3, node 301C represents the quantum bit (qubit) of 1, where n (number of shots the quantum bit needs to confidently determine a result) equals 500, and the counts of 0 and 1 are 10 and 290, respectively. The expected value for qubit 1 is undetermined because in this instance the number of shots has not reached the shot threshold n for that particular node.

Nodes 301-301C may collectively or individually be referred to as nodes 301 or node 301, respectively. It is noted that list 300 may include any number of nodes 301 and that list 300 is not to be limited in scope to the depicted three nodes 301.

In one embodiment, after creating the list of nodes, such as list 300 of nodes 301, the list is run by run engine 205 to determine which results of the quantum calculation are saved or discarded as discussed below.

In one embodiment, quantum processor 108 executes quantum circuit 109 to perform one complete execution of quantum circuit 109 corresponding to a shot. The result of the quantum calculation is then obtained, such as by run engine 205.

In one embodiment, run engine 205 updates the count of 0s and 1s in nodes 301 that have not reached their threshold number of shots (number of shots the represented quantum bit needs to confidently determine a result) based on the value of the result of the quantum calculation. In one embodiment, run engine 205 updates such a count using a count( ) function for 0s and 1s.

In one embodiment, run engine 205 determines whether the current shot count exceeds the threshold (n) (number of shots the represented quantum bit needs to confidently determine a result) for the top listed node 301 in list 300 that has not yet been evaluated for this particular shot, starting with the head of list 300 (e.g., node 301A).

If the shot count does not exceed the threshold (n) (number of shots the represented quantum bit needs to confidently determine a result), then the result of the quantum calculation is saved by run engine 205, such as on a storage device (e.g., database, memory of classical computer 102, disk unit of classical computer 102).

If, however, the shot count does exceed the threshold (n) (number of shots the represented quantum bit needs to confidently determine a result) for the evaluated node 301, then run engine 205 determines whether the measured state (in the result) of the quantum bit represented by the evaluated node 301 matches the expected value. If there is not a match, then run engine 205 discards the result of the quantum calculation thereby reducing the size of the full result (compilation of multiple shot results) which reduces the amount of classical data that needs to be stored, interpreted and transported for a given quantum circuit.

Upon discarding the result of the quantum calculation, run engine 205 determines if there any more nodes in list 300 with a shot count that is less than its threshold number (n) of shots. If so, then quantum processor 108 performs a subsequent execution (shot) of quantum circuit 109. Otherwise, the storage of the results of the quantum calculations is complete.

Furthermore, if, however, the measured state of the quantum bit of the result of the quantum calculation matches the expected value, then run engine 205 determines whether there are any more nodes 301 in list 300 to be evaluated. If so, then run engine 205 determines whether the shot count exceeds the threshold number (n) for the next listed node 301 in list 300 that has not yet been evaluated for this particular shot. Otherwise, the storage of the results of the quantum calculations is complete.

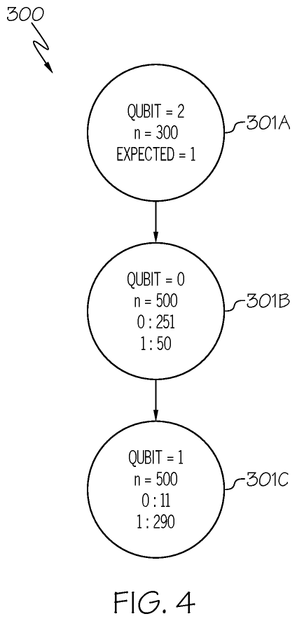

An illustration of the above process of running list 300 by run engine 205 is provided in connection with FIG. 4.

FIG. 4 illustrates running list 300 to determine which results of the quantum calculation are saved or discarded in accordance with an embodiment of the present invention.

Referring to FIG. 4, in conjunction with FIG. 3, if 300 shots were previously run and quantum processor 108 performs the next execution (shot 301) of quantum circuit 109 and the value of the quantum calculation is 001, then counts in qubit 0 (node 301B) and qubit 1 (node 301C) will be updated since the number of shots (301) is less than the threshold number (n) of shots the quantum bit represented by that node 301 needs to confidently determine a result. For example, the number of shots (301) is less than the threshold number (n) of shots the quantum bit needs to confidently determine a result for nodes 301B and 301C (threshold number (n) corresponds to 500 shots).

In one embodiment, each bit value of the result of the quantum calculation corresponds to a value of the measured state of the quantum bit which is represented by node 301. In one embodiment, the first bit position represents the measured state of the quantum bit associated with the first node 301 in list 300 and so forth. As a result, the count of 0 is incremented by 1 to 251, 11 for nodes 301B, 301C, respectively, for the quantum calculation of 001 since the underlined “0” in 001 represents the measured state of qubit 0 (node 301B) and the underlined “0” in 001 represents the measured state of qubit 1 (node 301C). In one embodiment, such counts are incremented, such as by the statement of counter=counter+1, where each state of the quantum bit (0 or 1) for each node 301 is counted via its own counter.

Furthermore, since the shot count (301) is greater than or equal to the threshold number (n) of shots (e.g., 300 shots) for confidently determining a result for the first node 301 (e.g., node 301A) listed in list 300 that has not yet been evaluated for this particular shot, a determination is made by run engine 205 as to whether the value (1) of the measured state of the quantum bit of the quantum calculation (001) which is represented by node 301A matches its expected value (1). For example, the underlined “1” in the result 001 represents the measured state of qubit 2 (node 301A).

Since in this case the value (1) of the measured state of the quantum bit of the quantum calculation (001) represented by node 301A matches the expected value (1) of node 301A, run engine 205 determines if there are more nodes in list 300. Since there are more nodes in list 300, run engine 205 determines if the shot count (301) exceeds the threshold number (n) of shots (e.g., 500 shots) for confidently determining a result for the next node 301 (e.g., node 301B) in list 300 that has not yet been evaluated. In this case, node 301B is the next node 301 in list 300 that has not yet been evaluated. Since its threshold number (n) of shots for confidently determining a result is 500, run engine 205 saves the result of the quantum calculation (001), such as on a storage device (e.g., database, memory of classical computer 102, disk unit of classical computer 102).

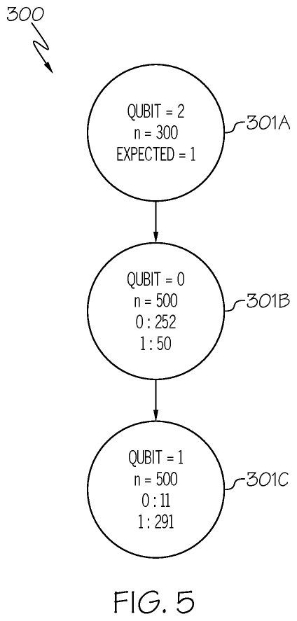

An example of performing a subsequent execution (subsequent shot, such as shot 302) of quantum circuit 109 is provided in FIG. 5.

FIG. 5 illustrates running list 300 to determine which results of the quantum calculations are saved or discarded involving a subsequent shot to the shot run in FIG. 4 in accordance with an embodiment of the present disclosure.

Referring to FIG. 5, in conjunction with FIGS. 3-4, if 301 shots were previously run and quantum processor 108 performs the next execution (shot 302) of quantum circuit 109 and the result of the quantum calculation is 010, then the counts in qubit 0 (node 301B) and qubit 1 (node 301C) will be updated since the number of shots (302) is less than the threshold number (n) of shots the quantum bit represented by that node 301 needs to confidently determine a result. For example, the number of shots (302) is less than the threshold number (n) of shots the quantum bit needs to confidently determine a result for nodes 301B and 301C (threshold number (n) corresponds to 500 shots). As a result, the count of 0 is incremented by 1 to 252 for node 301B and the count of 1 is incremented by 1 to 291 for node 301C since the underlined “0” in 010 represents the measured state of qubit 0 (node 301B) and the underlined “1” in 010 represents the measured state of qubit 1 (node 301C).

Furthermore, since the shot count (302) is greater than or equal to the threshold number (n) of shots (e.g., 300 shots) for confidently determining a result for the first node 301 (e.g., node 301A) listed in list 300 that has not yet been evaluated for this particular shot, a determination is made by run engine 205 as to whether the value (0) of the measured state of the result of the quantum calculation (010) represented by node 301A matches its expected value (1). For example, the underlined “0” in the result 010 represents the measured state of qubit 2 (node 301A).

Since in this case the value (0) of the measured state of the results of the quantum calculation (010) represented by node 301A does not match the expected value (1) of node 301A, run engine 205 discards the result of the quantum calculation (010) thereby reducing the size of the full result (compilation of multiple shot results) which reduces the amount of classical data that needs to be stored, interpreted and transported for a given quantum circuit.

A further description of these and other functions is provided below in connection with the discussion of the method for pruning quantum computational results.

Prior to the discussion of the method for pruning quantum computational results, a description of the hardware configuration of classical computer 102 (FIG. 1) is provided below in connection with FIG. 6.

Referring now to FIG. 6, FIG. 6 illustrates an embodiment of the present disclosure of the hardware configuration of classical computer 102 (FIG. 1) which is representative of a hardware environment for practicing the present disclosure.

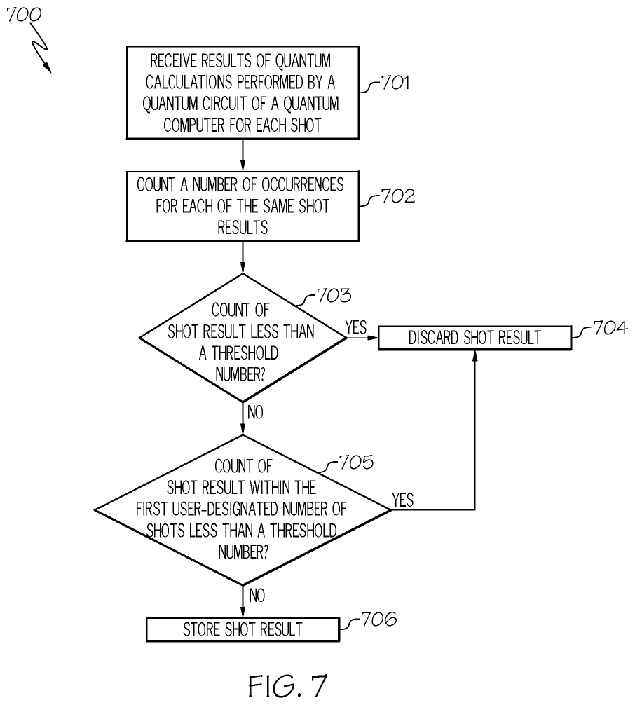

Classical computer 102 has a processor 601 connected to various other components by system bus 602. An operating system 603 runs on processor 601 and provides control and coordinates the functions of the various components of FIG. 6. An application 604 in accordance with the principles of the present disclosure runs in conjunction with operating system 603 and provides calls to operating system 603 where the calls implement the various functions or services to be performed by application 604. Application 604 may include, for example, pruner engine 201 (FIG. 2), list engine 202 (FIG. 2), calculator engine 203 (FIG. 2), comparison engine 204 (FIG. 2) and run engine 205 (FIG. 2). Furthermore, application 604 may include, for example, a program for pruning quantum computational results, as discussed further below in connection with FIGS. 7-11.

Referring again to FIG. 6, read-only memory (“ROM”) 605 is connected to system bus 602 and includes a basic input/output system (“BIOS”) that controls certain basic functions of classical computer 102. Random access memory (“RAM”) 606 and disk adapter 607 are also connected to system bus 602. It should be noted that software components including operating system 603 and application 604 may be loaded into RAM 606, which may be classical computer's 102 main memory for execution. Disk adapter 607 may be an integrated drive electronics (“IDE”) adapter that communicates with a disk unit 608, e.g., disk drive. It is noted that the program for pruning quantum computational results, as discussed further below in connection with FIGS. 7-11, may reside in disk unit 608 or in application 604.

Classical computer 102 may further include a communications adapter 609 connected to bus 602. Communications adapter 609 interconnects bus 602 with an outside network (e.g., network 113 of FIG. 1) to communicate with other devices, such as quantum computer 101.

In one embodiment, application 604 of classical computer 102 includes the software components of pruner engine 201, list engine 202, calculator engine 203, comparison engine 204 and run engine 205. In one embodiment, such components may be implemented in hardware, where such hardware components would be connected to bus 602. The functions discussed above performed by such components are not generic computer functions. As a result, classical computer 102 is a particular machine that is the result of implementing specific, non-generic computer functions.

In one embodiment, the functionality of such software components (e.g., pruner engine 201, list engine 202, calculator engine 203, comparison engine 204 and run engine 205) of classical computer 102, including the functionality for pruning quantum computational results, may be embodied in an application specific integrated circuit.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As stated above, quantum programming is the process of assembling sequences of instructions, called quantum programs, that are capable of running on a quantum computer. Quantum programming languages help express quantum algorithms using high-level constructs. A quantum program completes when the quantum circuit has been executed within a defined number of shots. A “shot” refers to one complete execution of the quantum circuit. The result space for a quantum program grows exponentially with the number of quantum bits measured. For example, for a quantum circuit with n measured quantum bits, there are up to 2′ possible shot results. Such shot results correspond to classical data that need to be stored or transmitted, such as to a classical storage device, for a given quantum circuit. As the shot number increases, therefore, a full result (compilation of multiple shot results) can potentially have very large results in terms of classical data usage. Currently, such an issue is addressed by returning combinations of equal shot results (i.e., two shot results are the same). However, this approach fails for noisy quantum computers because there can a large number of unique shot results simply due to noise. For example, one quantum algorithm for noisy quantum computers may need 10⁶ unique results, which can generate more data than is necessary for the algorithm to complete. As a result, there is not currently a means for effectively reducing the amount of classical data that needs to be stored or transmitted for a given quantum circuit.

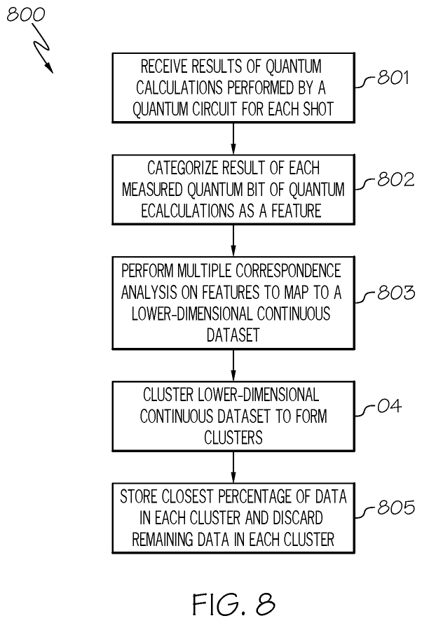

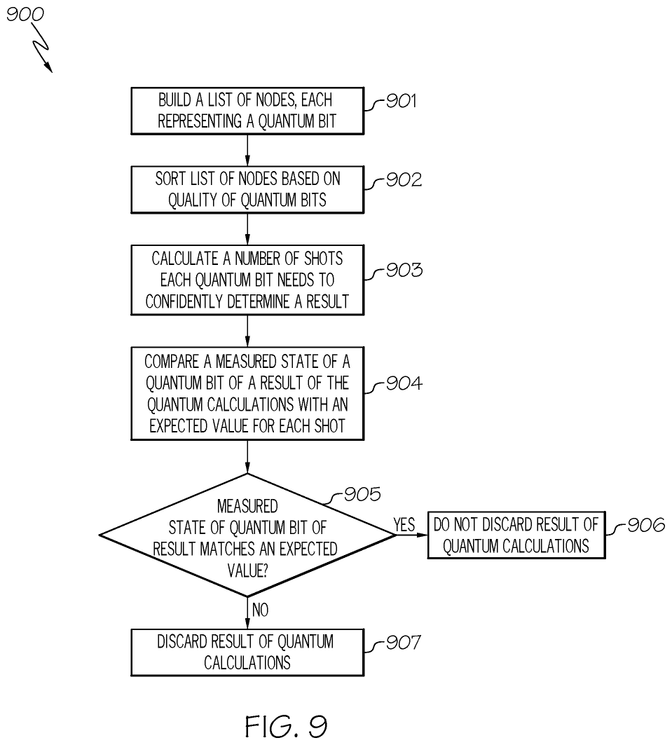

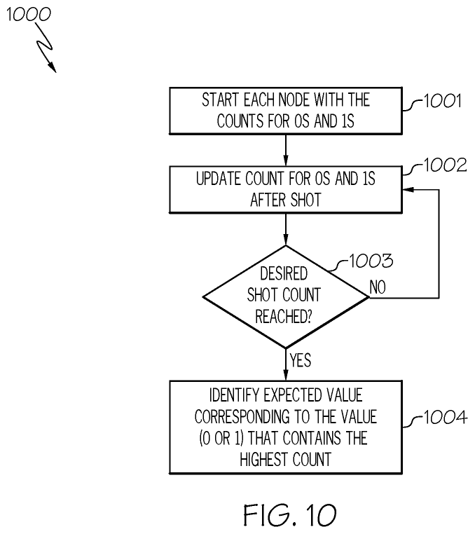

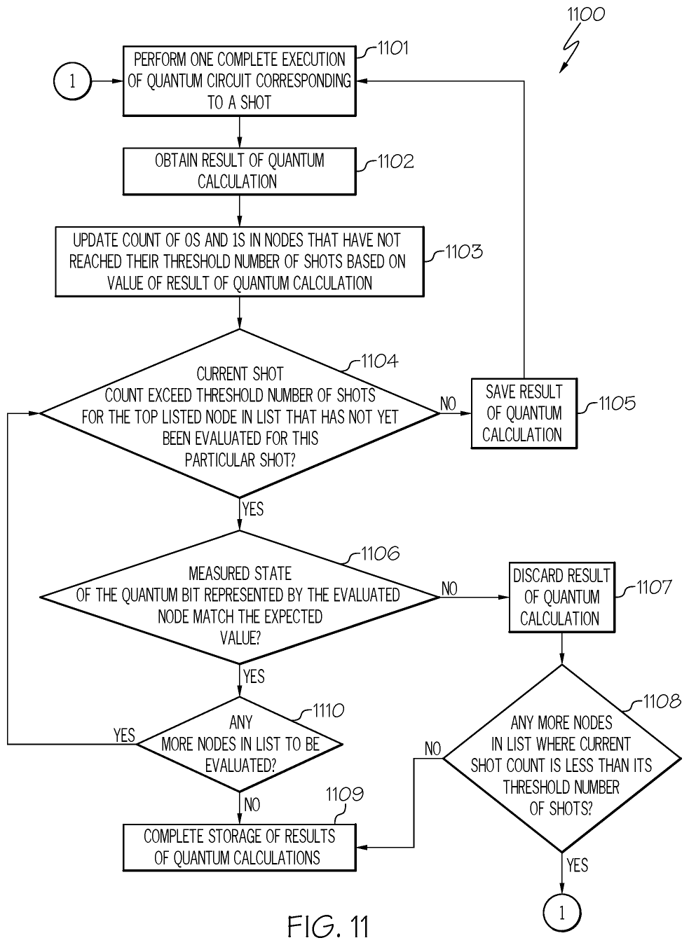

The embodiments of the present disclosure provide a means for reducing the size of the full result (compilation of multiple shot results) thereby reducing the amount of classical data that needs to be stored, interpreted and transmitted for a given quantum circuit by discarding shot results based on multiple algorithms (e.g., discarding shot results if they appear less often than a threshold number of time) or based on discarding the shot results if the measured state of a quantum bit of the results does not match an expected value as discussed below in connection with FIGS. 7-11. FIG. 7 is a flowchart of a method for pruning quantum computational results based on shot result counts. FIG. 8 is a flowchart of a method for pruning quantum computational results based on multiple correspondence analysis and clustering techniques. FIG. 9 is a flowchart of a method for pruning quantum computational results based on individual quantum bit values. FIG. 10 is a flowchart of a method for generating the expected value for each quantum bit represented by a node. FIG. 11 is a flowchart of a method for running the list of nodes to determine which results of the quantum calculations are saved or discarded.

As stated above, FIG. 7 is a flowchart of a method 700 for pruning quantum computational results based on shot result counts in accordance with an embodiment of the present disclosure.

Referring to FIG. 7, in conjunction with FIGS. 1-6, in step 701, pruner engine 201 of classical computer 102 receives the results of the quantum calculations performed by quantum circuit 109 of quantum computer 101 for each shot.

As discussed above, a “shot,” as used herein, refers to one complete execution of quantum circuit 109. The number of shots defines how many times quantum circuit 109 is to be repeatedly executed so as to obtain a better readout of a state of a quantum bit.

In step 702, pruner engine 201 of classical computer 102 counts the number of occurrences for each of the same shot results. For example, if the shot result for the execution of quantum circuit 109 was 001, then pruner engine 201 counts the number of occurrences for the shot result 001 in the results of the quantum calculations from quantum computer 101. For example, in one embodiment, pruner engine 201 utilizes the count( ) function for counting the number of times a shot result occurs in the results of the quantum calculations from quantum computer 101.

A “quantum program,” as discussed herein, defines the quantum circuit and the number of shots to execute quantum circuit 109. After quantum circuit 109 has completed the number of shots defined in the quantum program thereby providing a full result (compilation of multiple shot result), pruner engine 201 determines for each shot result whether the count (e.g., 3) of the shot result (e.g., 001) is less than a threshold number (e.g., 5), which may be user-designated, such as from an expert or administrator, as discussed below.

In step 703, pruner engine 201 of classical computer 102 determines for each shot result whether the count (e.g., 3) of the shot result (e.g., 001) is less than a threshold number (e.g., 5).

If the count of the shot result is less than a threshold number, then, in step 704, pruner engine 201 of classical computer 102 discards the shot result thereby reducing the size of the full result (compilation of multiple shot results) as well as reducing the amount of classical data that needs to be stored, interpreted and transported for a given quantum circuit 109.

For example, as stated above, in one embodiment, pruner engine 201 utilizes a naïve algorithm. For example, the pseudocode for such an algorithm is shown below:

```
Input: ε (threshold), results
For result in results:
  if result < ε * length(results):
    delete result from results
Return results
```

If, however, the count of the shot result is not less than a threshold number, then, in step 705, pruner engine 201 of classical computer 102 determines whether the count of the shot result within the first user-designated number of shots is less than a user-designated threshold number, where such user-designated values may be provided from an expert or administrator. For example, if the count of the shot result is 2 within the first user-designated number of shots (e.g., 100 shots), then a determination is made by pruner engine 201 as to whether such a count is less than the user-designated threshold number (e.g., 3).

If the count of the shot result within the first user-designated number of shots is less than a user-designated threshold number, then, in step 704, pruner engine 201 of classical computer 102 discards the shot result thereby reducing the size of the full result (compilation of multiple shot results) as well as reducing the amount of classical data that needs to be stored, interpreted and transported for a given quantum circuit.

If, however, the count of the shot result within the first user-designated number of shots is not less than a user-designated threshold number, then, in step 706, pruner engine 201 of classical computer 102 stores the shot result, such as on a storage device (e.g., database, memory 605, disk unit 608).

For example, as discussed above, in one embodiment, pruner engine 201 utilizes naïve filtering while running the solution for making such a determination. For example, the pseudocode for such an algorithm, where “m” corresponds to the user-designated number of shots, is shown below:

```
Input: ε (threshold), shots, m (warm up shots)
For i, shot in enumerate(shots):
  run shot, measure result
  if i >= m
    if result + saved results >= ε * i
      save result
  else:
    save result
Return results
```

In another example, pruner engine 201 utilizes a decision tree based filtering algorithm for discarding shot results with a count within the first user-designated number of shots being less than a user-designated threshold number. In one embodiment, the quantum bit results correspond to the features of the decision tree. In one embodiment, such a decision tree is pruned to a user-designated entropy.

Another technique for pruning quantum computational results is discussed below in connection with FIG. 8.

FIG. 8 is a flowchart of a method 800 for pruning quantum computational results based on multiple correspondence analysis and clustering techniques in accordance with an embodiment of the present disclosure.

Referring to FIG. 8, in conjunction with FIGS. 1-6, in step 801, pruner engine 201 of classical computer 102 receives the results of the quantum calculations performed by a quantum circuit, such as quantum circuit 109, for each shot.

In step 802, pruner engine 201 of classical computer 102 categorizes the result of each measured quantum bit of the quantum calculations as a feature.

In step 803, pruner engine 201 of classical computer 102 performs multiple correspondence analysis on the features to map to a lower-dimensional continuous dataset.

As stated above, in one embodiment, such features are mapped to a lower-dimensional continuous dataset by creating a matrix with values of zero or one. If a categorical variable has more than two different classes, this method binarized it. By using this method, multiple correspondence analysis (MCA) creates a matrix that consists of individual variables. Applying a standard correspondence analysis on this matrix is the next step. The result is a linear combination of rows that carries the most possible information of all categorical features.

In step 804, pruner engine 201 of classical computer 102 clusters the lower-dimensional continuous dataset to form clusters.

For example, in one embodiment, the number of clusters to identify is selected (e.g., K). K number of new points are then randomly generated. The distance between each data point and each centroid is measured. Each data point is then assigned to its closest centroid and the corresponding cluster.

In another example, in one embodiment, pruner engine 201 utilizes k-means clustering. In such an algorithm, the data space is divided into K distinct clusters. In one embodiment, K cluster centers are randomly selected and all data points are assigned to the nearest cluster centers. Then the cluster centers are re-calculated as the centroids of the newly formed clusters. The data points are re-assigned to the nearest cluster centers that were just re-calculated. This process, assigning data points to the cluster centers and re-calculating the cluster centers, is repeated until the cluster centers stop moving.

In step 805, pruner engine 201 of classical computer 102 stores the closest percentage of data in each cluster and discards the remaining data in each cluster. “Closest percentage of data,” as used herein, refers to the percentage of data closest to its assigned centroid. For example, pruner engine 201 may store the closest 5% of data in each cluster while discarding the remaining data. In one embodiment, such a percentage is user-designated, such as from an expert or administrator.

A discussion regarding another technique for pruning the quantum computational results is discussed below in connection with FIG. 9.

FIG. 9 is a flowchart of a method 900 for pruning quantum computational results based on individual quantum bit values in accordance with an embodiment of the present disclosure.

Referring to FIG. 9, in conjunction with FIGS. 1-6, in step 901, list engine 202 of classical computer 102 builds a list of nodes, each node representing a quantum bit.

As discussed above, in one embodiment, list engine 202 builds a list of nodes (e.g., nodes 301), each representing a quantum bit, by creating a class Node with the attributes of data (corresponding to the error rate) and next (corresponding to a pointer to the next node in the list). Furthermore, in one embodiment, list engine 202 uses the addNode( ) function to add a new node to the list.

In step 902, list engine 202 of classical computer 102 sorts the list of nodes (e.g., nodes 301) based on the quality of the represented quantum bits. That is, list engine 202 is configured to sort the list of nodes based on the error rates of the represented quantum bits, where the nodes listed higher in the list are representing quantum bits having a higher quality (lower error rate) than those nodes listed lower in the list. In one embodiment, list engine 202 sorts the list of nodes by creating a class SortList with the attributes of head and tail. The sortList( ) function is then used to sort the list of nodes by error rate.

As stated above, in one embodiment, the error rate of a quantum bit represented by a node is calculated by list engine 202 by aggregating the number of errors for the quantum bit. In one embodiment, such errors include readout error, gate error (e.g., Pauli-X if the gate is applied on the quantum bit), crosstalk, etc. In one embodiment, quantum error correction (QEC) is utilized by list engine 202 to identify errors, such as employing syndrome measurements to diagnose which error corrupts an encoded state of the quantum bit. In one embodiment, a multi-qubit measurement is performed that does not disturb the quantum information in the encoded state but retrieves information about the error. Depending on the QEC code used, syndrome measurements can determine the occurrence, location and type of errors.

In step 903, calculator engine 203 of classical computer 102 calculates the number of shots each quantum bit needs to confidently determine a result. “Confidently” determining a result, as used herein, refers to being assured that the result is correct.

As discussed above, in one embodiment, calculator engine 203 calculates the number of shots needed to drown out the aggregated error previously computed by list engine 202, where such a number of shots corresponds to the number of shots a quantum bit needs to confidently determine a result. In one embodiment, calculator engine 203 calculates the number of such shots by using a binomial distribution. For example, calculator engine 203 uses a confidence level and the number of correct readouts, both of which are configurable. For example, calculator engine 203 may solve the problem of calculating the number of shots required such that with high confidence (e.g., 90%), there will be at least 950 correct readouts given the probability of success is 1 minus the aggregated error. For instance, such a distribution may be modeled as: 0.95>=(n+1)(½)ⁿ, where n is the number of shots. Calculator engine 203 would then simply solve for n, corresponding to the number of shots the quantum bit needs to confidently determine a result.

In step 904, comparison engine 204 of classical computer 102 compares a measured state of a quantum bit of a result of the quantum calculations with an expected value for each shot.

In step 905, run engine 205 of classical computer 102 determines if the measured state of the quantum bit of the result matches an expected value.

If the measured state of the quantum bit of the result matches the expected value, then, in step 906, run engine 205 of classical computer 102 does not discard the result of the quantum calculations.

If, however, the measured state of the quantum bit of the result does not match the expected value, then, in step 907, run engine 205 of classical computer 102 discards the result of the quantum calculations thereby reducing the size of the full result (compilation of multiple shot results) which reduces the amount of classical data that needs to be stored, interpreted and transported for a given quantum circuit 109.

As discussed above, comparison engine 204 compares a result of the quantum calculations with an expected value for each shot. Such an expected value is generated as discussed below in connection with FIG. 10.

FIG. 10 is a flowchart of a method 1000 for generating the expected value for each quantum bit represented by a node in accordance with an embodiment of the present disclosure.

Referring to FIG. 10, in conjunction with FIGS. 1-6 and 9, in step 1001, list engine 202 of classical computer 102 starts each node 301 with the counts for 0s and 1s, which are initialized at 0.

In step 1002, list engine 202 of classical computer 102 updates the counts for 0s and 1s after a shot.

In step 1003, list engine 202 of classical computer 102 determines whether the desired shot count (n) (corresponding to the number of shots the quantum bit needs to confidently determine a result as discussed above) is reached for that particular node 301.

If the desired shot count (n) (corresponding to the number of shots the quantum bit needs to confidently determine a result as discussed above) has not been reached, then list engine 202 of classical computer 102 updates the counts for 0s and 1s for a subsequent shot in step 1002.

If, however, the desired shot count (n) (corresponding to the number of shots the quantum bit needs to confidently determine a result as discussed above) has been reached, then, in step 1004, list engine 202 of classical computer 102 identifies the expected value as corresponding to the value (0 or 1) that contains the highest count.

For example, as shown in FIG. 3, node 301A has an expected value of 1 because at 300 shots (desired shot count was 300), there was a greater number of 1s counted than 0s.

A discussion regarding running the list of nodes, such as list 300 of nodes 301, to determine which results of the quantum calculation are saved or discarded is discussed below in connection with FIG. 11.

FIG. 11 is a flowchart of a method 1100 for running the list of nodes to determine which results of the quantum calculation are saved or discarded in accordance with an embodiment of the present disclosure.

Referring to FIG. 11, in conjunction with FIGS. 1-6 and 9-10, in step 1101, quantum processor 108 performs one complete execution of quantum circuit 109 corresponding to a shot.

In step 1102, run engine 205 of classical computer 102 obtains the result of the quantum calculation (e.g., 100).

In step 1103, run engine 205 of classical computer 102 updates the count of 0s and 1s in nodes 301 that have not reached their threshold number of shots (number of shots the represented quantum bit needs to confidently determine a result) based on the value of the result of the quantum calculation. As discussed above, in one embodiment, run engine 205 updates such a count using a count( ) function for 0s and 1s.

In step 1104, run engine 205 of classical computer 102 determines whether the current shot count exceeds the threshold (n) (number of shots the represented quantum bit needs to confidently determine a result) for the top listed node 301 in list 300 that has not yet been evaluated for this particular shot, starting with the head of list 300 (e.g., node 301A).

If the current shot count does not exceed the threshold (n) (number of shots the represented quantum bit needs to confidently determine a result), then, in step 1105, the result of the quantum calculation is saved by run engine 205 of classical computer 102, such as on a storage device (e.g., database, memory 605, disk unit 608).

If, however, the shot count does exceed the threshold (n) (number of shots the represented quantum bit needs to confidently determine a result) for the evaluated node 301, then, in step 1106, run engine 205 of classical computer 102 determines whether the measured state (in the result) of the quantum bit represented by the evaluated node 301 matches the expected value.

If there is not a match, then, in step 1107, run engine 205 of classical computer 102 discards the result of the quantum calculation thereby reducing the size of the full result (compilation of multiple shot results) which reduces the amount of classical data that needs to be stored, interpreted and transported for a given quantum circuit 109.

Upon discarding the result of the quantum calculation, run engine 205 of classical computer 102 determines if there any more nodes 301 in list 300 where the current shot count is less than its threshold number (n) of shots (number of shots the represented quantum bit needs to confidently determine a result) in step 1108.

If there are more nodes 301 in list 300 where the current shot count that is less than its threshold number (n) of shots (number of shots the represented quantum bit needs to confidently determine a result), then quantum processor 108 performs a subsequent execution (shot) of quantum circuit 109 in step 1101.

If, however, there are no more nodes 301 in list 300 where the current shot count is less than its threshold number (n) of shots, then, in step 1109, run engine 205 of classical computer 102 has completed the storage of the results of the quantum calculations.

Returning to step 1106, if, however, the measured state (in the result) of the quantum bit represented by the evaluated node 301 matches the expected value, then, in step 1110, run engine 205 of classical computer 102 determines whether there are any more nodes 301 in list 300 to be evaluated.

If there are more nodes 301 in list 300 to be evaluated, then run engine 205 of classical computer 102 determines whether the current shot count exceeds the threshold number (n) of shots (number of shots the represented quantum bit needs to confidently determine a result) for the next listed node 301 in list 300 that has not yet been evaluated for this particular shot in step 1104.

If, however, there are no more nodes 301 in list 300 to be evaluated, then run engine 205 of classical computer 102 has completed the storage of the results of the quantum calculations in step 1109.

In one embodiment, quantum bits may be correlated with each other. For example, referring to FIG. 3, suppose that qubit 1 301C is correlated with qubit 2 301A, and therefore, should always contain the same value as qubit 2 301A. In such a situation, 500 shots may not be needed to be collected for qubit 1 301C since the shot result may be deemed to be discarded if the measured states of qubit 1 301C and qubit 2 301A in the shot result do not match.

In one embodiment, correlation may be detected by analyzing quantum circuit 109 (e.g., entanglement) or by heuristics (e.g., quantum search heuristics). For example, quantum entanglement may be detected (and hence correlation between quantum bits) using stabilizer formalism. In another example, quantum entanglement may be detected if multiple qubits unitary gates are applied to them.

As a result of the foregoing, the principles of the present disclosure provide a means for reducing the size of the full result (compilation of multiple shot results) thereby reducing the amount of classical data that needs to be stored, interpreted and transported. As a result, the response time is improved while utilizing less resource consumption. Furthermore, there is faster performance and better scaling for large quantum computers (e.g., tens of thousands of qubits).

Furthermore, the principles of the present disclosure improve the technology or technical field involving quantum computing.

As discussed above, quantum programming is the process of assembling sequences of instructions, called quantum programs, that are capable of running on a quantum computer. Quantum programming languages help express quantum algorithms using high-level constructs. A quantum program completes when the quantum circuit has been executed within a defined number of shots. A “shot” refers to one complete execution of the quantum circuit. The result space for a quantum program grows exponentially with the number of quantum bits measured. For example, for a quantum circuit with n measured quantum bits, there are up to 2′ possible shot results. Such shot results correspond to classical data that need to be stored or transmitted, such as to a classical storage device, for a given quantum circuit. As the shot number increases, therefore, a full result (compilation of multiple shot results) can potentially have very large results in terms of classical data usage. Currently, such an issue is addressed by returning combinations of equal shot results (i.e., two shot results are the same). However, this approach fails for noisy quantum computers because there can a large number of unique shot results simply due to noise. For example, one quantum algorithm for noisy quantum computers may need 10⁶ unique results, which can generate more data than is necessary for the algorithm to complete. As a result, there is not currently a means for effectively reducing the amount of classical data that needs to be stored or transmitted for a given quantum circuit.

Embodiments of the present disclosure improve such technology by receiving the results of quantum calculations performed by a quantum circuit of a quantum computer, such as for each shot. A “shot,” as used herein, refers to one complete execution of the quantum circuit. The number of shots defines how many times the quantum circuit is to be repeatedly executed so as to obtain a better readout of a state, such as a state of a quantum bit. A measured state of a quantum bit of a result of the quantum calculation is then compared with an expected value. For example, the measured state of a quantum bit (e.g., 0) of the result of the quantum calculation may be compared with its expected value (e.g., 1). In one embodiment, the expected value of a quantum bit may be determined by counting the number of 0s and 1s corresponding to the state of the quantum bit after each shot until the number of shots equals the number of shots (e.g., 500 shots) needed to confidently determine an expected value. The expected value then corresponds to the value (0 or 1) that contains the highest count. If the compared measured state of the quantum bit of the result of the quantum calculation (e.g., measured state of the quantum bit is 1) matches the expected value (e.g., 1), then the result of the quantum calculation is not discarded. If, however, the measured state of the quantum bit of the result of the quantum calculation (e.g., measured state of the quantum bit is 0) does not match the expected value (e.g., 1), then the result of the quantum calculation is discarded. In this manner, the size of the full result (compilation of multiple shot results) is reduced thereby reducing the amount of classical data that needs to be stored, interpreted and transported. Furthermore, in this manner, there is an improvement in the technical field involving quantum computing.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

In one embodiment of the present disclosure, a method for pruning quantum computational results comprises receiving a plurality of results of quantum calculations from a quantum computer. The method further comprises discarding a first result of the plurality of results of quantum calculations in response to a measured state of a quantum bit of the first result not matching an expected value.

Additionally, in one embodiment of the present disclosure, the method further comprises building a list of nodes, each node representing a quantum bit. The method additionally comprises sorting the list of nodes based on a quality of the quantum bits.

Furthermore, in one embodiment of the present disclosure, the method additionally comprises calculating a number of shots each quantum bit needs to confidently determine a result.

Additionally, in one embodiment of the present disclosure, the method further comprises updating a count of 0s and 1s in nodes based on a value of the first result for those nodes that have not reached the number of shots its represented quantum bit needs to confidently determine a result.

Furthermore, in one embodiment of the present disclosure, the method additionally comprises discarding the first result of the plurality of results in response to a count of the first result appearing less often than a threshold number of times.

Additionally, in one embodiment of the present disclosure, the method further comprises discarding the first result of the plurality of results in response to a count of the first result within a designated number of shots appearing less often than a threshold number of times.

Furthermore, in one embodiment of the present disclosure, the method additionally comprises categorizing a result of each measured quantum bit of the quantum calculations as a feature. The method further comprises performing a multiple correspondence analysis on the features to map to a lower-dimensional continuous dataset. Furthermore, the method comprises clustering the lower-dimensional continuous dataset to form clusters. Additionally, the method comprises storing a closest percentage of data in each cluster and discarding remaining data in each cluster.

Other forms of the embodiments of the method described above are in a system and in a computer program product.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for pruning quantum computational results, the method comprising:
receiving a plurality of results of quantum calculations from a quantum computer; and
discarding a first result of said plurality of results of quantum calculations in response to a measured state of a quantum bit of said first result not matching an expected value.

2. The method as recited in claim 1 further comprising:
building a list of nodes, each node representing a quantum bit; and
sorting said list of nodes based on a quality of said quantum bits.

3. The method as recited in claim 2 further comprising:
calculating a number of shots each quantum bit needs to confidently determine a result.

4. The method as recited in claim 3 further comprising:
updating a count of 0s and 1s in nodes based on a value of said first result for those nodes that have not reached said number of shots its represented quantum bit needs to confidently determine a result.

5. The method as recited in claim 1 further comprising:
discarding said first result of said plurality of results in response to a count of said first result appearing less often than a threshold number of times.

6. The method as recited in claim 1 further comprising:
discarding said first result of said plurality of results in response to a count of said first result within a designated number of shots appearing less often than a threshold number of times.

7. The method as recited in claim 1 further comprising:
categorizing a result of each measured quantum bit of said quantum calculations as a feature;
performing a multiple correspondence analysis on said features to map to a lower-dimensional continuous dataset;
clustering said lower-dimensional continuous dataset to form clusters; and
storing a closest percentage of data in each cluster and discarding remaining data in each cluster.

8. A computer program product for pruning quantum computational results, the computer program product comprising one or more computer readable storage mediums having program code embodied therewith, the program code comprising programming instructions for:
receiving a plurality of results of quantum calculations from a quantum computer; and
discarding a first result of said plurality of results of quantum calculations in response to a measured state of a quantum bit of said first result not matching an expected value.

9. The computer program product as recited in claim 8, wherein the program code further comprises the programming instructions for:
building a list of nodes, each node representing a quantum bit; and
sorting said list of nodes based on a quality of said quantum bits.

10. The computer program product as recited in claim 9, wherein the program code further comprises the programming instructions for:
calculating a number of shots each quantum bit needs to confidently determine a result.

11. The computer program product as recited in claim 10, wherein the program code further comprises the programming instructions for:
updating a count of 0s and 1s in nodes based on a value of said first result for those nodes that have not reached said number of shots its represented quantum bit needs to confidently determine a result.

12. The computer program product as recited in claim 8, wherein the program code further comprises the programming instructions for:
discarding said first result of said plurality of results in response to a count of said first result appearing less often than a threshold number of times.

13. The computer program product as recited in claim 8, wherein the program code further comprises the programming instructions for:
discarding said first result of said plurality of results in response to a count of said first result within a designated number of shots appearing less often than a threshold number of times.

14. The computer program product as recited in claim 8, wherein the program code further comprises the programming instructions for:
categorizing a result of each measured quantum bit of said quantum calculations as a feature;
performing a multiple correspondence analysis on said features to map to a lower-dimensional continuous dataset;
clustering said lower-dimensional continuous dataset to form clusters; and
storing a closest percentage of data in each cluster and discarding remaining data in each cluster.

15. A system, comprising:
a memory for storing a computer program for pruning quantum computational results; and
a processor connected to said memory, wherein said processor is configured to execute program instructions of the computer program comprising:
receiving a plurality of results of quantum calculations from a quantum computer; and
discarding a first result of said plurality of results of quantum calculations in response to a measured state of a quantum bit of said first result not matching an expected value.

16. The system as recited in claim 15, wherein the program instructions of the computer program further comprise:
building a list of nodes, each node representing a quantum bit; and
sorting said list of nodes based on a quality of said quantum bits.

17. The system as recited in claim 16, wherein the program instructions of the computer program further comprise:
calculating a number of shots each quantum bit needs to confidently determine a result.

18. The system as recited in claim 17, wherein the program instructions of the computer program further comprise:
updating a count of 0s and 1s in nodes based on a value of said first result for those nodes that have not reached said number of shots its represented quantum bit needs to confidently determine a result.

19. The system as recited in claim 15, wherein the program instructions of the computer program further comprise:
discarding said first result of said plurality of results in response to a count of said first result appearing less often than a threshold number of times.

20. The system as recited in claim 15, wherein the program instructions of the computer program further comprise:
discarding said first result of said plurality of results in response to a count of said first result within a designated number of shots appearing less often than a threshold number of times.
